(19) United States
(12) Patent Application Publication
(10) Pub. No.: US 2007/0154837 A1
(43) Pub. Date: Jul. 5, 2007

(54) Composition for hard mask and method for manufacturing semiconductor device

(75) Inventors: Ki Lyoung Lee, Hwaseong-si (KR); Geun Su Lee, Yongin-si (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Gyeonggi-do (KR)

(21) Appl. No.: 11/416,271

(22) Filed: May 2, 2006

(30) Foreign Application Priority Data
Dec. 30, 2005 (KR) 10-2005-0135357

(51) Int. Cl. G03C 1/00

(52) U.S. Cl. 430/270.1

(57) ABSTRACT

Disclosed herein is a composition that includes a silicon compound, a novolak resin, a catalyst, and an organic solvent, which can be used as a part of hard mask film over an underlying layer during the manufacture of a semiconductor device. The hard mask film is useful in the formation of a uniform pattern on the device.

### BACKGROUND OF THE INVENTION

### Field of the Disclosure

The disclosure generally relates to a hard mask composition, and a method for manufacturing a semiconductor device using the composition to form a uniform pattern.

### BRIEF DESCRIPTION OF RELATED TECHNOLOGY

As the fields of application of semiconductor devices have expanded, there has been a need to manufacture a memory device of high capacity with improved integrity. Semiconductor manufacturing processes necessarily include a lithography process for forming a line pattern (such as a gate line and a bit line), or a contact hole pattern (such as a bit line contact).

In order to form a critical dimension (CD) below 0.07 μm, the lithography process has been developed with Deep Ultra Violet (DUV) light sources of short wavelength such as ArF (193 nm) or VUV (157 nm) instead of long wavelength light sources such as I-line or KrF (248 nm).

Generally, the lithography process includes a process for forming a bottom anti-reflection layer in the bottom of the photoresist film so as to prevent scattered reflection from a bottom layer of a photoresist film and remove standing waves resulting from thickness variation of a photoresist film.

As device sizes become smaller, the thickness of photoresist layers also becomes smaller to prevent photoresist patterns from collapsing during the semiconductor manufacturing process. Therefore, the use of hard mask films has been limited to those having a relatively larger or similar etching selectivity to the photoresist film or an organic anti-reflection layer to secure the etching selectivity to the bottom underlying layer when an underlying layer is etched with the photoresist pattern as an etching mask.

More specifically (and with reference to FIG. 1), a complex multi-layer structure (which includes an amorphous carbon hard mask film 3, a SiON hard mask film 5 having a desirable etching selectivity to an amorphous carbon hard mask film 3, an organic anti-reflection layer 7 and a photoresist pattern 9 sequentially formed on an underlying layer 1) is formed to secure the etching selectivity of the hard mask in a conventional underlying layer etching process.

Consequently, films that serve as the organic anti-reflection layer and the hard mask film are required to simplify the process.

A conventional composition for the organic anti-reflection layer satisfies the following conditions. First, while an anti-reflection layer is coated and then a photoresist layer is coated, the anti-reflection layer should not be dissolved by an organic solvent in a photoresist composition. Thus, the anti-reflection layer is designed to have a cross-linking structure in a process for coating an anti-reflection layer composition and baking the composition to deposit the anti-reflection layer. Here, other chemical materials should not be generated as by-products. Second, the composition is required to contain a material having a high light absorbance to light sources to inhibit reflection from a bottom layer. Third, the composition is required to contain a catalyst for activating the cross-linking reaction in the process for depositing the anti-reflection composition.

Moreover, a film used as the hard mask film is required to have the excellent etching selectivity to the bottom underlying layer.

### SUMMARY OF THE INVENTION

Disclosed herein is a hard mask composition, which serves as an anti-reflection layer and has a relatively larger or similar etching selectivity to that of a photoresist material when an underlying layer pattern is formed. Also, disclosed herein is a method for manufacturing a semiconductor device to form a uniform pattern using the hard mask composition and also simplify the process.

### BRIEF DESCRIPTION OF THE DRAWINGS

For a more complete understanding of the invention, reference should be made to the following detailed description and accompanying drawings, wherein:

FIG. 1 is a cross-sectional diagram illustrating a multi-layer structure of a conventional process including a hard mask film.

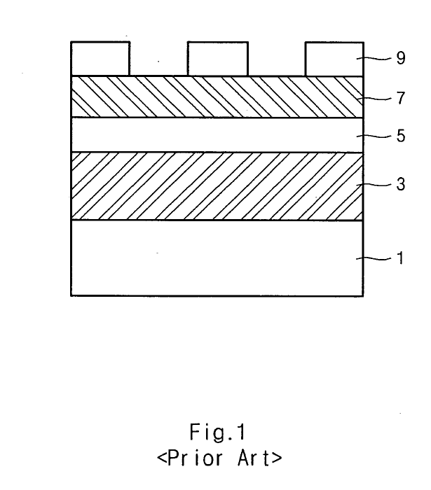

FIGS. 2a through 2d are cross-sectional diagrams illustrating a disclosed method for manufacturing a semiconductor device.

FIG. 3 is a SEM photograph illustrating a photoresist pattern obtained from Example 1.

FIG. 4 is a SEM photograph illustrating an underlying layer pattern after an etching process of Example 1.

While the disclosed composition and method are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION OF THE PRESENTLY PREFERRED EMBODIMENTS

Disclosed herein is a hard mask composition comprising: (i) a silicon compound of Formula 1

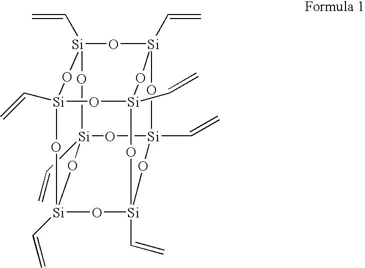

(ii) a novolak resin of Formula 2

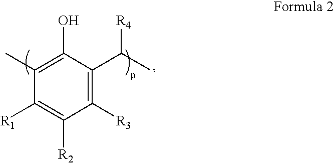

(iii) a catalyst, and (iv) an organic solvent, wherein R₁ through R₄ are individually H, linear or branched C₁-C₅ alkyl or C₃-C₁₀ cycloalkene with at least one substituted with hydroxyl group; and p is an integer ranging from 5 to 500.

The silicon compound is an essential material to improve an etching selectivity of a hard mask film of the present invention. That is, the silicon compound comprises Si in an amount ranging from 15 wt % to 45 wt %, based on the total wt % of the silicon compound, thereby forming a cross-linking reaction between an oxygen included in etching gas and a silicon element. As a result, a hard mask film of the present invention secures an etching selectivity to an underlying layer.

The novolak resin of Formula 2 has a molecular weight ranging from 100 to 5,000. Since the novolak resin has a high light absorbance to a DUV light source such as ArF (193 nm), reflected lights and standing waves generated from the bottom layer are removed to increase the light absorbance of the wavelength region, and the novolak resin reacts with the silicon compound to form a cross-linking polymer.

Preferably, the novolak resin of Formula 2 is represented by the resin depicted in Formulas 2a or 2b, below, and is present in an amount ranging from 10 parts by weight to 100 parts by weight, based on 100 parts by weight of the silicon compound of Formula 1.

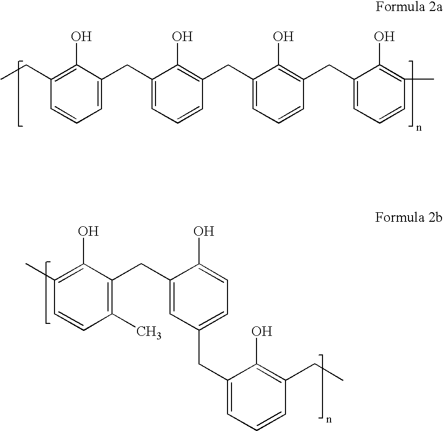

wherein n is an integer ranging from 1 to 500, preferably 1 to 200.

If the cross-linking polymer between the silicon compound and the novolak resin is not sufficiently formed in the disclosed composition, the coating characteristic of the composition for hard mask is degraded, and the hard mask film is dissolved in a photoresist solvent when a subsequent photoresist is formed. On the other hand, because a cross-linking density becomes higher when a cross-linking polymer is excessively formed, the etching selectivity of the hard mask film becomes higher than that of the photoresist film to decrease an etching speed.

The disclosed hard mask composition includes a catalyst selected from the group consisting of EPOCROS™ (manufactured by Nihon Shokubai Co. Ltd.) which is an oxazoline-functional polymer, a thermal acid generator, a photoacid generator, and combinations thereof to increase the cross-linking between the compounds in baking.

The catalyst is preferably present in a range from 0.1 parts by weight to 10 parts by weight, based on 100 parts by weight of the silicon compound.

Any of conventional thermal acid generators can be used. More specifically, thermal acid generators are selected from the group consisting of Formula 3, Formula 4, and mixtures thereof.

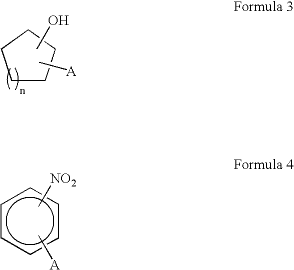

wherein A is a functional group comprising sulfonyl group, preferably 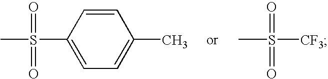
and n is 0 or 1.

The photoacid generator is selected from the group consisting of phthalimidotrifluoromethane sulfonate, dinitrobenzyltosylate, n-decyldisulfone, naphtylimidotrifluoromethane sulfonate, diphenyl p-methoxyphenylsulfonium triflate, diphenyl p-toluenylsulfonium triflate, diphenyl p-isobutylphenylsulfonium triflate, triphenylhexafluoro arsenate, triphenylhexafluoro antimonate, triphenylsulfonium triflate, dibutylnaphtylsulfonium triflate, and mixtures thereof.

The catalyst serves as a catalyst for activating the cross-linking reaction between the silicon compound and an —OH group of the novolak resin as a light absorbing agent. For example, when a thermal process such as baking is performed after the hard mask composition (containing the catalyst, such the thermal acid generator or the photoacid generator) is coated on a wafer, acid is generated from the catalyst, and the above-described cross-linking reaction occurs by the generated acid. As a result, the hard mask film, which is not dissolved in the photoresist solvent, is formed.

Because the above-described disclosed hard mask composition contains a cross-linking structure including a benzene ring having a high light absorbance to short wavelength, the composition serves as an anti-reflection layer to remove scattered reflection lights and standing waves generated from the bottom layer in an exposure process and also secures an etching selectivity to an underlying layer by the cross-linking structure between the compounds.

Any of organic solvents used as a conventional solvent for an anti-reflection layer composition can be used. Specifically, the organic solvent is selected from the group consisting of ethyl 3-ethoxypropionate, methyl 3-methoxypropionate, cyclohexanone, propylene glycol monomethyl ether acetate (PGMEA), 2-heptanone, ethyl lactate, and mixtures thereof. Preferably, the organic solvent is present in an amount ranging from 500 parts by weight to 10,000 parts by weight, based on 100 parts by weight of the silicon compound. The hard mask film having a sufficient thickness cannot be obtained when the organic solvent is present in the amount of more than 10,000 parts by weight. When the organic solvent is present in the amount of less than 500 parts by weight, the hard mask film is thickly formed so that it is difficult to etch a pattern vertically.

The disclosed hard mask film is formed as a single layer to simplify the process step. The disclosed hard mask film is formed with equipment for forming a conventional photoresist film. It is easy to remove the hard mask film by a common removal process with a thinner, an alkali solvent or a fluorine gas.

Also, disclosed herein is a method for manufacturing a semiconductor device, which includes coating a hard mask film on a underlying layer; patterning the hard mask film to form a hard mask pattern; and patterning the underlying layer using the hard mask pattern as a mask to form an underlying pattern, wherein the hard mask film is formed of the disclosed composition for a hard mask.

The above-described method further comprises forming an amorphous carbon layer or a polymer layer having a high carbon content on the underlying layer before coating the disclosed composition for hard mask to secure the etching selectivity of the hard mask film.

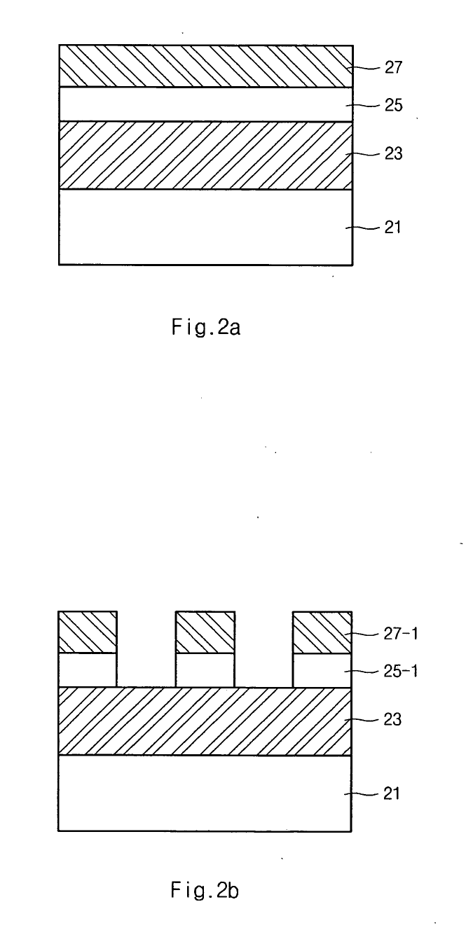

Hereinafter, the disclosed method for forming a pattern of a semiconductor device is described in detail. Referring to FIG. 2a, an underlying layer 23 is formed over a substrate 21. The disclosed composition for hard mask is coated over the underlying layer 23, and then a baking process is performed to form a hard mask film 25. The underlying layer includes an oxide nitride film or an oxide film.

The baking process is performed at a temperature ranging from 100° C. to 300° C. for 1 minute to 5 minutes. Here, the cross-linking density in the hard mask film becomes higher by acid generated from a thermal acid generator or a photoacid generator in baking process. The hard mask film has a thickness ranging from 500 Å to 2000 Å.

A conventional chemical amplification-type photoresist composition is coated on the hard mask film 25, and then baked to form a photoresist film 27.

An exposure and developing process is performed on the photoresist film 27 of FIG. 2a to form a photoresist pattern 27-1. Then, an etching process is performed on the hard mask film 25 with the photoresist pattern 27-1 as an etching mask to form a hard mask film pattern 25-1 as shown in FIG. 2b.

Thereafter, an etching process is performed on the underlying layer 23 with a deposition pattern including the photoresist pattern 27-1 and the hard mask pattern 25-1 of FIG. 2b as an etching mask to form an underlying layer pattern 23-1 as shown in FIG. 2c.

Preferably, the etching process is performed with the etching gas selected from the group consisting of Cl₂, Ar, N₂O₂, CF₄, C₂F₆, and mixtures thereof. The power can be variously applied depending on etching equipment, used gases and process kinds in the etching process. Preferably, the power is applied by a source RF power ranging from 300 W to 1000 W and the bias power ranging from 0 W to 300 W.

Thereafter, a removal process is performed with a conventional thinner composition, an alkali solvent, or a fluorine gas, to remove the photoresist pattern 27-1 and the hard mask pattern 25-1 remaining after the etching process so that the underlying layer pattern 23-1 is formed over the substrate 21 as shown in FIG. 2d.

The disclosed hard mask composition and the disclosed method for manufacturing a semiconductor device are applied to a process for forming an ultra fine pattern with DUV light sources of short wavelength such as KrF, VUV, EUV, E-beam, X-ray or ion-beam, preferably ArF (193 nm).

Additionally, there is provided a semiconductor device manufactured by the disclosed method including the pattern formation process.

The disclosed compositions will be described in detail by referring to examples below, which are not intended to limit the present invention.

### I. Preparation of a Disclosed Composition for Hard Mask

### Preparation Example 1

To propylene glycol monomethyl ether acetate (PGMEA) (400 g) were dissolved the compound of Formula 1 (5 g, Aldrich Co.), the compound of Formula 2 a having an average molecular weight of 2,000 (5 g) and EPOCROSTM (manufactured by Nihon Shokubai Co. Ltd.) (0.5 g). Then, the resulting mixture was filtered with a 0.2 μm filter to obtain a disclosed composition for hard mask.

### Preparation Example 2

To propylene glycol momethyl ether acetate (PGMEA) (400 g) were dissolved the compound of Formula 1 (5 g, Aldrich. Co.), the compound of Formula 2b having an average molecular weight of 2,000 (5 g), 2-hydroxyhexyl p-toluenylsufonate (0.4 g) as a thermal acid generator, and triphenylsulfonium triflate (0.05 g) as a photoacid generator. Then, the resulting mixture was filtered through a 0.2 μm filter to obtain a disclosed composition for hard mask.

### II. Formation of a Disclosed Pattern

### Example 1

An oxide nitride film as an underlying layer was formed on a silicon wafer treated with hexamethyldisilazane (HMDS), and the hard mask composition (3ml) of Preparation Example 1 was spin-coated thereon with 3000 rpm. Then, the resulting structure was baked at about 200° C. for about 90 seconds to form a hard mask film having a thickness of 920 Å.

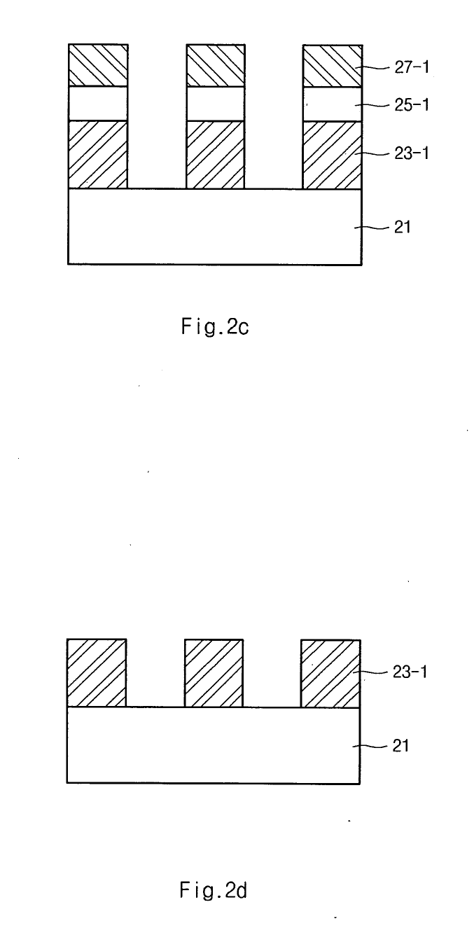

A photoresist film (Shin-Etsu Co., X-121) for 193 nm was coated at a thickness of 0.17 μm on the hard mask film, soft-baked at about 120° C. for about 90 seconds, exposed with an ArF scanner (NA=0.85, ASML Co.), and then post-baked at about 120° C. for about 90 seconds. After post-baking, it was developed in 2.38 wt % tetramethylammonium hydroxide (TMAH) aqueous solution to obtain 80 nm L/S photoresist pattern (see FIG. 3).

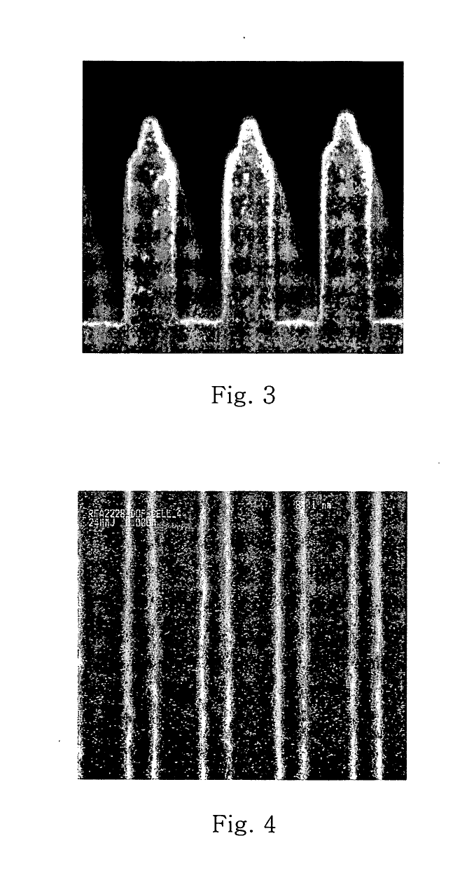

Thereafter, the hard mask pattern was etched with the photoresist pattern as an etching mask to form a hard mask pattern, and an etching process was performed on the underlying layer with the same etching process condition with the hard mask pattern as an etching mask to form a 80 nm L/S underlying layer pattern (see FIG. 4). Here, the etching process was performed with CF₄/Ar mixture etching gas (RF power: about 700 W, bias power: about 150 W).

### Example 2

The procedure of Example 1 was repeated using the composition for hard mask of Preparation Example 2 instead of the composition of Preparation Example 1 to obtain a 80 nm L/S underlying layer pattern.

### Example 3

An oxide nitride film as an underlying layer was formed on a silicon wafer treated with HMDS, and an amorphous carbon layer having a thickness of 200 nm was formed thereon by a Chemical Vapor Deposition (CVD) method. Then, the composition (3 ml) for hard mask of Preparation Example 1 was spin-coated thereon with 3000 rpm, and baked at about 200° C. for about 90 seconds to form a hard mask film having a thickness of 920 Å.

A photoresist film (Shin-Etsu Co., X-121) for 193 nm was coated at a thickness of 0.17 μm on the hard mask film, soft-baked at about 120° C. for about 90 seconds, exposed with an ArF scanner (NA=0.85, ASML Co.), and then post-baked at about 120° C. for about 90 seconds. After post-baking, it was developed in 2.38wt % TMAH aqueous solution for about 30 seconds, to obtain a 80 nm L/S photoresist pattern.

Thereafter, the hard mask pattern was etched with the photoresist pattern as an etching mask to form a hard mask pattern, and an etching process was performed on the underlying layer with the same etching process condition with the hard mask pattern as an etching mask to form a 80 nm L/S underlying layer pattern. Here, the etching process was performed with CF₄/Ar mixture etching gas (RF power: about 700 W, bias power: about 150 W).

### Example 4

The procedure of Example 3 was repeated using the composition for hard mask of Preparation Example 2 instead of the composition of Preparation Example 1 to obtain a 80 nm L/S underlying layer pattern.

As described above, there is provided a disclosed composition for hard mask including a silicon compound and a novolak resin. The disclosed composition formed over the underlying layer is used as a hard mask film in a subsequent etching process so that a uniform underlying layer pattern is obtained. Also, a pattern formation process is simplified to reduce process cost.

What is claimed is:

1. A composition for a hard mask comprising:
(i) a silicon compound of Formula 1 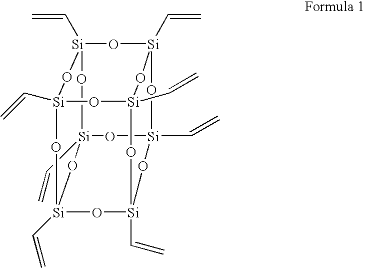
(ii) a novolak resin of Formula 2 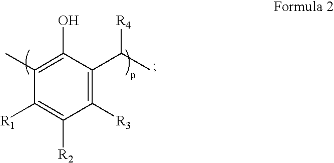
(iii) a catalyst; and,
(iv) an organic solvent,
wherein R₁ through R₄ are individually H, linear or branched C₁-C₅ alkyl, or C₃-C₁₀ cycloalkene with at least one substituted with hydroxyl group; and p is an integer ranging from 5 to 500.

2. The composition of claim 1, wherein the silicon compound comprises Si in an amount ranging from 15 wt % to 45 wt %, based on the total weight of the silicon compound.

3. The composition of claim 1, wherein the novolak resin has a molecular weight ranging from 100 to 5,000.

4. The composition of claim 1, wherein the novolak resin is represented by Formula 2a or 2b: 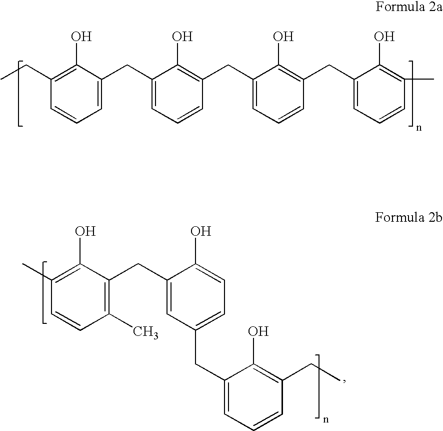
wherein n is an integer ranging from 1 to 500.

5. The composition of claim 4, wherein n is an integer ranging from 1 to 200.

6. The composition of claim 1, wherein the novolak resin is present in an amount ranging from 10 parts by weight to 100 parts by weight, based on 100 parts by weight of the silicon compound of Formula 1.

7. The composition of claim 1, wherein the catalyst is selected from the group consisting of an oxazoline-functional polymer, a thermal acid generator, a photoacid generator, and combinations thereof.

8. The composition of claim 7, wherein the thermal acid generator is selected from the group consisting of Formula 3, Formula 4, and mixture thereof: 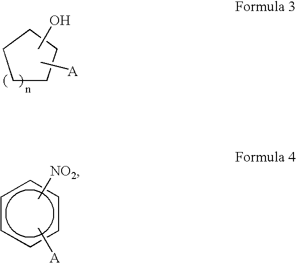
wherein A is a functional group comprising sulfonyl group; and n is 0 or 1.

9. The composition of claim 7, wherein the photoacid generator is selected from the group consisting of phthalimidotrifluoromethane sulfonate, dinitrobenzyltosylate, n-decyldisulfone, naphtylimidotrifluoromethane sulfonate, diphenyl p-methoxyphenylsulfonium triflate, diphenyl p-toluenylsulfonium triflate, diphenyl p-isobutylphenylsulfonium triflate, triphenylhexafluoro arsenate, triphenylhexafluoro antimonate, triphenylsulfonium triflate, dibutylnaphtylsulfonium triflate, and mixtures thereof.

10. The composition of claim 1, wherein the catalyst is present in an amount ranging from 0.1 parts by weight to 10 parts by weight, based on 100 parts by weight of the silicon compound.

11. The composition of claim 1, wherein the organic solvent is selected from the group consisting of ethyl 3-ethoxypropionate, methyl 3-methoxypropronate, cyclohexanone, propylene glycol monomethyl ether acetate (PGMEA), 2-heptanone, ethyl lactate, and mixtures thereof.

12. The composition of claim 1, wherein the organic solvent is present in an amount ranging from 500 parts by weight to 10,000 parts by weight, based on 100 parts by weight of the silicon compound.

13. A method for manufacturing a semiconductor device comprising:
coating a hard mask film on a underlying layer;
patterning the hard mask film to form a hard mask pattern; and
patterning the underlying layer using the hard mask pattern as a mask to form an underlying pattern;
wherein said hard mask film is formed of a hard mask composition comprising:
(i) a silicon compound of Formula 1 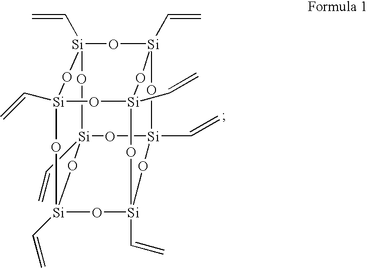
(ii) a novolak resin of Formula 2 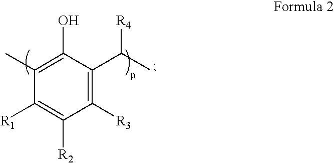
(iii) a catalyst; and,
(iv) an organic solvent,
wherein R₁ through R₄ are individually H, linear or branched C₁-C₅ alkyl, or C₃-C₁₀ cycloalkene with at least one substituted with hydroxyl group; and p is an integer ranging from 5 to 500.

14. The method of claim 13, wherein the underlying layer is an oxide film or an oxide nitride film.

15. The method of claim 13, wherein the hard mask film has a thickness ranging from 500 Å to 2000 Å.

16. The method of claim 13, wherein the patterning process of steps (b) and (c) is performed with one or more etching gases selected from the group consisting of Cl₂, Ar, N₂O₂, CF₄ and C₂F₆.

17. The method of claim 13, wherein the step (a) further comprises forming an amorphous carbon layer or a polymer layer having a high carbon content on the underlying layer before forming the hard mask layer.

18. A semiconductor device manufactured by the method of claim 13.
